(19) United States
(12) Patent Application Publication
(10) Pub. No.: US 2024/0375655 A1
(43) Pub. Date: Nov. 14, 2024

(54) APPARATUS AND METHOD FOR DRIVING ASSISTANCE

(71) Applicant: HL KLEMOVE CORP., Incheon (KR)

(72) Inventor: Rakyoung KIM, Gyeonggi-do (KR)

(21) Appl. No.: 18/533,197

(22) Filed: Dec. 8, 2023

(30) Foreign Application Priority Data
May 8, 2023 (KR) 10-2023-0059282

(51) Int. Cl. B60W 30/16

(52) U.S. Cl. CPC B60W 30/162

(57) ABSTRACT

A driving assistance apparatus includes: a front sensor mounted to or on a vehicle and having a field of sensing in front of a host vehicle; and a controller configured to process data obtained from the front sensor. The controller is configured to increase a set distance from the host vehicle to a front vehicle and reduce a set maximum limit to an acceleration of the host vehicle based on receiving a control signal for fuel efficiency improvement during the activation of Adaptive Cruise Control (ACC).

### CROSS-REFERENCE TO RELATED APPLICATION(S)

This application is based on and claims priority under 35 U.S.C. § 119 to Korean Patent Application No. 10-2023-0059282, filed on May 8, 2023, in the Korean Intellectual Property Office, the disclosure of which is incorporated by reference herein in its entirety.

### BACKGROUND

### 1. Technical Field

The present disclosure generally relates to a driving assistance apparatus and method capable of minimizing or reducing fuel consumption during activation of an Adaptive Cruise Control (ACC) function.

### 2. Description of the Related Art

The number of peoples who use vehicles as universal means of transportation is increasing. The development of vehicle technology facilitates long-distance movements and makes lives easier. However, in densely populated regions such as Korea, traffic congestion often occurs due to bad traffic conditions.

Lately, to reduce drivers' loads and promote convenience, studies or developments into vehicles with Advanced Driver Assist System (ADAS) for actively providing information about a vehicle's state, a driver's state, and/or surrounding environments are actively being conducted.

ADAS mounted on a vehicle may include, for example, but not limited to, one or more of Lane Departure Warning (LDW), Lane Keeping Assist (LKA), High Beam Assist (HBA), Autonomous Emergency Braking (AEB), Traffic Sign Recognition (TSR), Adaptive Cruise Control (ACC), Blind Spot Detection (BSD), etc.

### SUMMARY

It is an aspect of the present disclosure to provide a driving assistance apparatus and method capable of enabling a stable movement of a vehicle to a target gas station by minimizing or reducing fuel consumption in response to turning-on of a fuel warning light or a driver's input for fuel efficiency improvement during activation of Adaptive Cruise Control (ACC).

Additional aspects of the disclosure will be set forth in part in the description which follows and, in part, will be obvious from the description, or may be learned by practice of the disclosure.

In accordance with an aspect of the present disclosure, a driving assistance apparatus includes: a front sensor mounted on a vehicle and having a field of sensing toward a front direction of the vehicle; and a controller configured to process data obtained by the front sensor, wherein the controller is configured to increase a distance to a front vehicle and reduce a maximum acceleration, based on reception of a control signal for fuel efficiency improvement during activation of Adaptive Cruise Control (ACC).

The controller may determine a control factor for adjusting the distance to the front vehicle and the maximum acceleration based on a distance to empty, in response to receiving a control signal corresponding to turning-on of a fuel warning light or a control signal corresponding to a driver's input for fuel efficiency improvement.

The control factor may be inversely proportional to the distance to empty.

The control factor may be determined to a greater value as a distance to a destination is longer, under a condition of the same distance to empty.

The control factor may be determined to a smaller value as a distance to a destination is shorter, under a condition of the same distance to empty.

The controller may calculate a second distance by multiplying the control factor by a first distance to a front vehicle, which is set before the control signal is received.

The controller may increase the distance to the front vehicle by adding the second distance to the first distance.

The controller may calculate a second maximum acceleration, which is smaller than a first maximum acceleration set before the control signal is received, by multiplying a reciprocal number of the control factor by the first maximum acceleration.

The controller may determine the second maximum acceleration as a maximum acceleration of the ACC in a section corresponding to the increased distance to the front vehicle.

The controller is configured to determine a maximum speed of the ACC by adding a speed control factor, which is inversely proportional to the control factor, to a speed of the front vehicle.

In accordance with an aspect of the disclosure, a method for assisting driving includes: obtaining data through a front sensor having a field of sensing toward a front direction of a vehicle; processing data obtained by the front sensor; and increasing a distance to a front vehicle and reducing a maximum acceleration, based on receiving a control signal for fuel efficiency improvement during activation of Adaptive Cruise Control (ACC).

The increasing of the distance to the front vehicle and the reducing of the maximum acceleration may include determining a control factor for adjusting the distance to the front vehicle and the maximum acceleration based on a distance to empty, in response to receiving a control signal corresponding to turning-on of a fuel warning light or a control signal corresponding to a driver's input for fuel efficiency improvement.

The control factor may be inversely proportional to the distance to empty.

The control factor may be determined to a greater value as a distance to a destination is longer, under a condition of the same distance to empty.

The control factor may be determined to a smaller value as a distance to a destination is shorter, under a condition of the same distance to empty.

The method further comprises calculating a second distance by multiplying the control factor by a first distance to a front vehicle, which is set before the control signal is received.

The method further comprises increasing the distance to the front vehicle by adding the second distance to the first distance.

The method further comprises calculating a second maximum acceleration, which is smaller than a first maximum acceleration set before the control signal is received, by multiplying a reciprocal number of the control factor by the first maximum acceleration.

The method further comprises determining the second maximum acceleration as a maximum acceleration of the ACC in a section corresponding to the increased distance to the front vehicle.

The method further comprises determining a maximum speed of the ACC by adding a speed control factor, which is inversely proportional to the control factor, to a speed of the front vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows a block diagram of a vehicle and a driving assistance apparatus according to an embodiment of the present disclosure;

FIG. 2 shows an example of fields of view of a camera, a radar, and a lidar included in a driving assistance apparatus according to an embodiment of the present disclosure;

FIG. 3 shows a functional block diagram of a controller included in a driving assistance apparatus according to an embodiment of the present disclosure;

FIG. 4 schematically shows functions of a control factor determining module shown in FIG. 3;

FIG. 5 schematically shows functions of a control module shown in FIG. 3;

FIGS. 6 and 7 are graphs showing a relationship between a distance to empty and a control factor according to an embodiment of the present disclosure;

FIG. 8 shows an example of a driving control of Adaptive Cruise Control (ACC) according to turning-on of a fuel warning light according to an embodiment of the present disclosure; and

FIGS. 9 and 10 show flowcharts for illustrating operations of a driving assistance apparatus according to an embodiment of the present disclosure.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

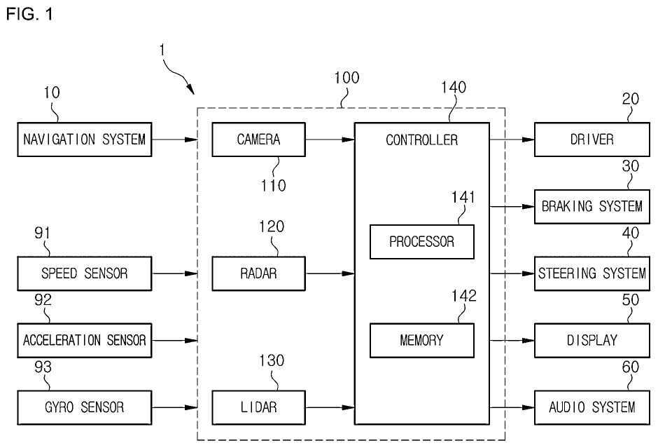

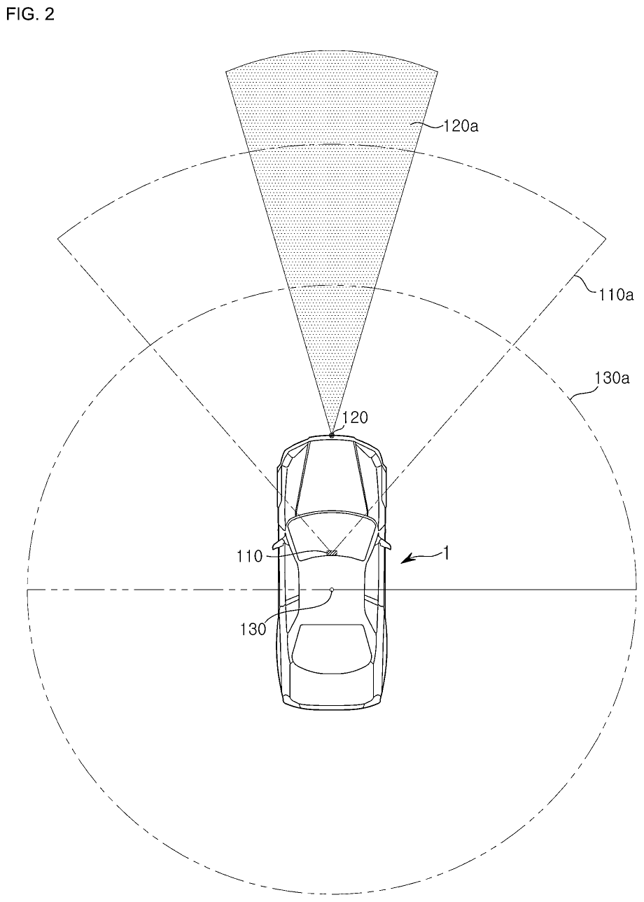

FIG. 1 shows a configuration of a vehicle according to an embodiment of the present disclosure. FIG. 2 shows fields of view of a camera, a radar, and a lidar included in a driving assistance apparatus according to an embodiment of the present disclosure.

As shown in FIG. 1, a vehicle 1 may include a navigation system 10, a driving device 20, a brake system 30, a steering system 40, a display 50, an audio system 60, and/or a driving assistance apparatus 100. Also, the vehicle 1 may further include one or more sensors such as 91, 92, and 93 for detecting dynamic of the vehicle 1. For example, the vehicle 1 may further include a speed sensor 91 configured to detect a speed of the vehicle 1 in a longitudinal direction of the vehicle 1, an acceleration sensor 92 configured to detect an acceleration in the longitudinal direction of the vehicle 1 and an acceleration in a traverse direction of the vehicle 1, and/or a gyro sensor 93 configured to detect a yaw rate, a roll rate, and a pitch rate of the vehicle 1.

The above-mentioned electrical components may communicate with each other through an in-vehicle communication network. For example, the electrical components 10, 20, 30, 40, 50, 60, 91, 92, 93, and 100 included in the vehicle 1 may transmit and receive data to and from each other through a communication network, for example, but not limited to, the Ethernet, Media Oriented Systems Transport (MOST), Flexray, Controller Area Network (CAN), Local Interconnect Network (LIN), etc.

The navigation system 10 may calculate or create a travel route of the vehicle 1 to a destination input by a driver, and provide the created route to the driver. For instance, the navigation system 10 may receive a Global Navigation Satellite System (GNSS) signal from a GNSS, and identify an absolute position (or coordinates) of the vehicle 1 based on the GNSS signal. The navigation system 10 may create the travel route to the destination based on a position (or coordinates) of the destination input by the driver and a current position (or coordinates) of the vehicle 1.

The navigation system 10 may provide map data and information related to the position of the vehicle 1 to the driving assistance apparatus 100. Also, the navigation system 10 may provide information about a travel route to a destination to the driving assistance apparatus 100. For example, the navigation system 10 may provide the driving assistance apparatus 100 with information about a distance to an access road at which the vehicle 1 will enter a new road or a distance to an exit road at which the vehicle 1 will exit a road on which the vehicle 1 currently travels.

The driving device 20 may drive or move the vehicle 1, and include, for example, but not limited to, an engine, an Engine Management System (EMS), a transmission, and a Transmission Control Unit (TCU). The engine may generate power for driving the vehicle 1, and the EMS may control the engine in response to the driver's intention or a control signal of a controller 140 to accelerate through an accelerator pedal or a request or command signal from the driving assistance apparatus 100. The transmission may increase or reduce and transfer power generated by the engine to vehicle wheels, and the TCU may control the transmission in response to the driver's shift command through a shift lever and/or a request or command signal from the driving assistance apparatus 100.

The brake system 30 may slow down or stop the vehicle 1, and include, for example, but not limited to, a brake caliper and an Electronic Brake Control Module (EBCM). The brake caliper may decelerate or stop the vehicle 1 by using friction with a brake disc, and the EBCM may control the brake caliper in response to the driver's intention to brake through a brake pedal and/or a request or command signal from the driving assistance apparatus 100. For example, the EBCM may receive a deceleration request including a deceleration from the driving assistance apparatus 100, and control the brake caliper electrically or hydraulically to decelerate the vehicle 1 depending on the requested deceleration.

The steering system 40 may include an Electronic Power Steering (EPS) control module. The steering system 40 may steer or change a traveling direction of the vehicle 1, and the EPS control module may assist an operation of the steering system 40 in response to the driver's intention to steer through a steering wheel for the driver to easily control the steering wheel. Also, the EPS control module may control the steering system 40 in response to a request or command signal from the driving assistance apparatus 100. For example, the EPS control module may receive a steering request signal including a steering torque from the driving assistance apparatus 100, and control the steering system 40 to steer the vehicle 1 based on the requested steering torque.

The display 50 may include a cluster, a head-up display, a center fascia monitor, etc., and provide various information and entertainment to the driver through images and sound. For example, the display 50 may provide the driver with driving information of the vehicle 1, warning messages, and so on.

The audio system 60 may include one or a plurality of speakers, and provide the driver with various information and entertainment through sound. For example, the audio system 60 may provide the driver with driving information of the vehicle 1, warning sound or messages, and so on.

The driving assistance apparatus 100 may communicate with the navigation system 10, the plurality of sensors 91, 92, and 93, the driving device 20, the brake system 30, the steering system 40, the display 50, and the audio system 60 through the in-vehicle communication network. The driving assistance apparatus 100 may receive information about a travel route from a current location to a destination and information related to the location of the vehicle 1 from the navigation system 10, and obtain information about a speed, an acceleration, and/or an angular speed of the vehicle 1 from the plurality of sensors 91, 92, and 93.

The driving assistance apparatus 100 may provide the driver with various functions for safety. For example, the driving assistance apparatus 100 may provide one or more of Lane Departure Warning (LDW), Lane Keeping Assist (LKA), High Beam Assist (HBA), Autonomous Emergency Braking (AEB), Traffic Sign Recognition (TSR), Adaptive Cruise Control (ACC), Blind Spot Detection (BSD), etc.

The driving assistance apparatus 100 may include a camera 110, a radar 120, a lidar 130, and a controller 140. The driving assistance apparatus 100 is not limited to the embodiment shown in FIG. 1. For example, in the driving assistance apparatus 100 shown in FIG. 1, at least one sensor of the camera 110, the radar 120, or the lidar 130 may be omitted, or various sensors capable of detecting one or more objects around the vehicle 1 may be added. A front sensor capable of detecting objects ahead of the vehicle 1 may include one or more of the camera 110, the radar 120, or the lidar 130 described above.

The camera 110, the radar 120, the lidar 130, and the controller 140 may be arranged separately from each other. For example, the controller 140 may be installed in a housing that is separated from a housing of the camera 110, a housing of the radar 120, and a housing of the lidar 130. The controller 140 may transmit and receive data to and from the camera 110, the radar 120, or the lidar 130 through a broadband network.

Also, at least some of the camera 110, the radar 120, the lidar 130, and the controller 140 may be integrated into one piece body. For example, the camera 110 and the controller 140 may be provided in one housing, the radar 120 and the controller 140 may be provided in one housing, or the lidar 130 and the controller 140 may be provided in one housing.

The camera 110 may capture or photograph surroundings of the vehicle 1 to obtain image data about the surroundings of the vehicle 1. For example, as shown in FIG. 2, the camera 110 may be installed in a front wind shield of the vehicle 1, and have a field of view 110a toward a front direction of the vehicle 1.

The camera 110 may include a plurality of lenses and an image sensor. The image sensor may include a plurality of photodiodes configured to convert light into electrical signals or data, and the plurality of photodiodes may be arranged in a two-dimensional matrix form.

Image data may include information about objects around the vehicle 1, for example, another vehicle, a pedestrian, a cyclist, or lanes (markers dividing roads).

The driving assistance apparatus 100 may include an image processor configured to process image data of the camera 110, and the image processor may be integrated into, for example, the camera 110 or the controller 140.

The image processor may obtain image data from the image sensor of the camera 110, and process the image data to detect and identify an object around the vehicle 1. For example, the image processor may identify whether an object located around the vehicle 1 is another vehicle, a pedestrian, or a cyclist through image processing.

The image processor may transfer information about the identified object around the vehicle 1 to the controller 140.

The radar 120 may transmit or emit transmission radio waves toward surroundings of the vehicle 1, and detect a surrounding object around the vehicle 1 based on reflection radio waves reflected from the surrounding object. For example, the radar 120 may be installed at a grille or bumper of the vehicle 1, as shown in FIG. 2, and have a field of sensing 120a toward the front direction of the vehicle 1.

The radar 120 may include a transmission antenna (or a transmission antenna array) configured to transmit or emit transmission radio waves toward the surroundings of the vehicle 1, and a reception antenna (or a reception antenna array) configured to receive reflection radio waves reflected from an object.

The radar 120 may obtain radar data from the transmission radio waves transmitted from the transmission antenna and the reflection radio waves received by the reception antenna. The radar data may include position information (for example, distance information) and/or speed information of objects located ahead of the vehicle 1.

The driving assistance apparatus 100 may include a signal processor configured to process the radar data of the radar 120, and the signal processor may be integrated into, for example, the radar 120 or the controller 140.

The signal processor may obtain the radar data from the reception antenna of the radar 120, and generate data about a motion of an object by clustering a reflection point of a reflection signal. For example, the signal processor may obtain a distance to an object based on a time difference between a time of the transmission of transmission radio waves and a time of the receipt of reflection radio waves, and obtain a speed of the object based on a difference between a frequency of the transmission radio waves and a frequency of the reflection radio waves.

The signal processor may transfer the data about the motion of the object located around the vehicle 1, the data obtained from the radar data, to the controller 140.

The lidar 130 may emit light (for example, infrared light) toward surroundings of the vehicle 1, and detect an object located around the vehicle 1 based on reflection light reflected from the object. For example, the lidar 130 may be installed at or near a roof of the vehicle 1, as shown in FIG. 2, and have a field of view 130a toward all directions from the vehicle 1.

The lidar 130 may include a light source (for example, a light emitting diode, a light emitting diode array, a laser diode, or a laser diode array) configured to emit light (for example, infrared light, etc.), and an optical sensor (for example, a photodiode or a photodiode array) configured to receive light (for example, infrared light, etc.). Also, the lidar 130 may further include a driving device configured to move or rotate the light source and/or the optical sensor if necessary.

The lidar 130 may radiate light through the light source while the light source and/or the optical sensor rotates, and receive light reflected from an object through the optical sensor, thereby obtaining lidar data.

The lidar data may include relative positions (e.g. distances to surrounding objects and/or directions of the surrounding objects) and/or relative speeds of objects located around the vehicle 1 with respect to the vehicle 1.

The driving assistance apparatus 100 may include a signal processor configured to process lidar data of the lidar 130, and the signal processor may be integrated into, for example, the lidar 130 or the controller 140.

The signal processor may generate data about a motion of an object by clustering a reflection point by reflection light. The signal processor may obtain a distance to the object based on a time difference between a light transmission time and a light reception time. Also, the signal processor may obtain a direction (or angle) of the object with respect to a traveling direction of the vehicle 1, based on a direction in which the light source radiates light, when the optical sensor receives reflection light.

The signal processor may transfer data about the motion of the object located around the vehicle 1, which is obtained from the lidar data, to the controller 140.

The controller 140 may be electrically or communicationally connected to the camera 110, the radar 120, and/or the lidar 130. Also, the controller 140 may be connected to the navigation system 10, the driving device 20, the brake system 30, the steering system 40, the display 50, the audio system 60 and/or the plurality of sensors 91, 92, and 93 through the in-vehicle communication network.

The controller 140 may process image data of the camera 110, radar data of the radar 120, and/or lidar data of the lidar 130, and provide control signals to the driving device 20, the brake system 30, and/or the steering system 40.

The controller 140 may include a processor 141 and a memory 142.

The memory 142 may store a program and/or data for processing image data, radar data, and/or lidar data. Also, the memory 142 may store a program and/or data for generating a driving/braking/steering signal. Also, the memory 142 may store a table listing values of control factors according to changes in distance-to-empty to adjust a driving control according to the ACC when a fuel warning light is turned on or a driver's input for requesting fuel efficiency improvement is received during the activation of the ACC. Details about the control factors will be described below.

The memory 142 may temporarily or permanently store image data received from the camera 110, radar data received from the ladar 120, and/or lidar data received from the lidar 130, and temporarily or permanently store results of processing on the image data, the radar data, and/or the lidar data by the processor 141.

Also, the memory 142 may include a High Definition (HD) map. The HD map may include detailed information about surfaces of roads or crossroads, such as lanes, traffic lights, crossroads, road signs, etc., unlike normal maps. Particularly, the HD map may three-dimensionally implement landmarks (for example, lanes, traffic lights, crossroads, road signs, etc.) on a road in which a vehicle is traveling during driving.

The memory 142 may include one or more of volatile memory, such as Static Random Access Memory (S-RAM) and Dynamic Random Access Memory (D-RAM), and non-volatile memory, such as flash memory, Read Only Memory (ROM), and Erasable Programmable Read Only Memory (EPROM).

The processor 141 may process image data of the camera 110, radar data of the radar 120, and/or lidar data of the lidar 130. For example, the processor 141 may fuse image data, radar data, and/or lidar data, and output the fused data.

The processor 141 may generate a driving signal, a braking signal, and/or a steering signal for controlling the driving device 20, the brake system 30, and/or the steering system 40, respectively, based on processing on the fused or fusion data. For example, the processor 141 may predict a collision with an object around the vehicle 1 by using the fused or fusion data, and control the driving device 20, the brake system 30, and/or the steering system 40 to steer or brake the vehicle 1 according to a result of the prediction of the collision with the object.

The processor 141 may include an image processor configured to process image data of the camera 110, a signal processor configured to process radar data of the radar 120 and/or lidar data of the lidar 130, or a Micro Control Unit (MCU) configured to generate a driving/braking/steering signal.

As described above, the controller 140 may provide a driving signal, a braking signal, or a steering signal based on image data of the camera 110, radar data of the radar 120, or lidar data of the lidar 130. The camera 110, the radar 120, and the lidar 130 described above are referred to as front sensors, for convenience of description.

Hereinafter, detailed operations of the driving assistance apparatus 100 will be described in more detail.

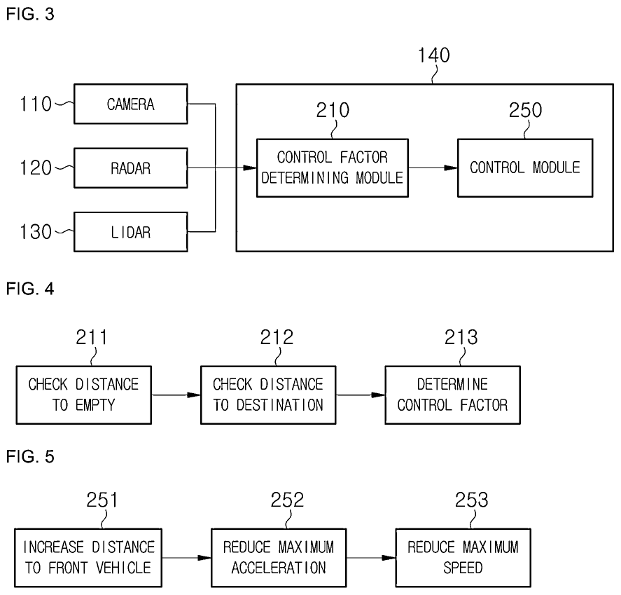

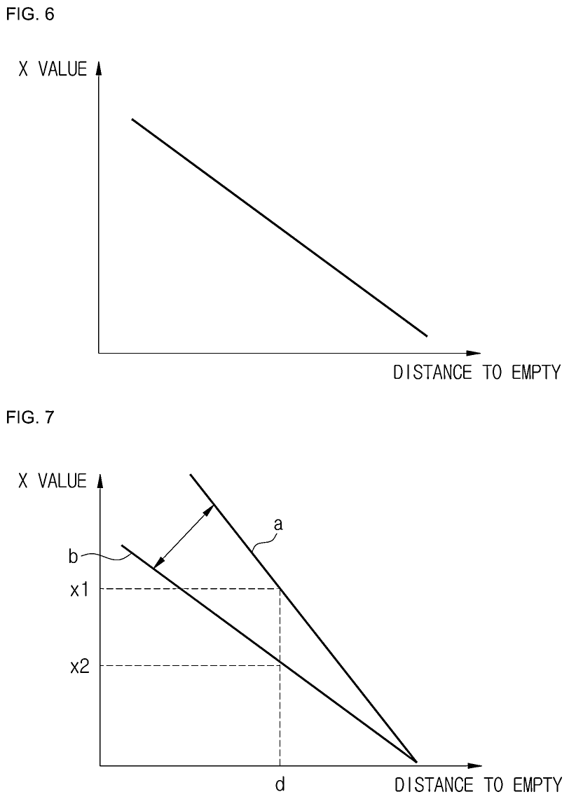

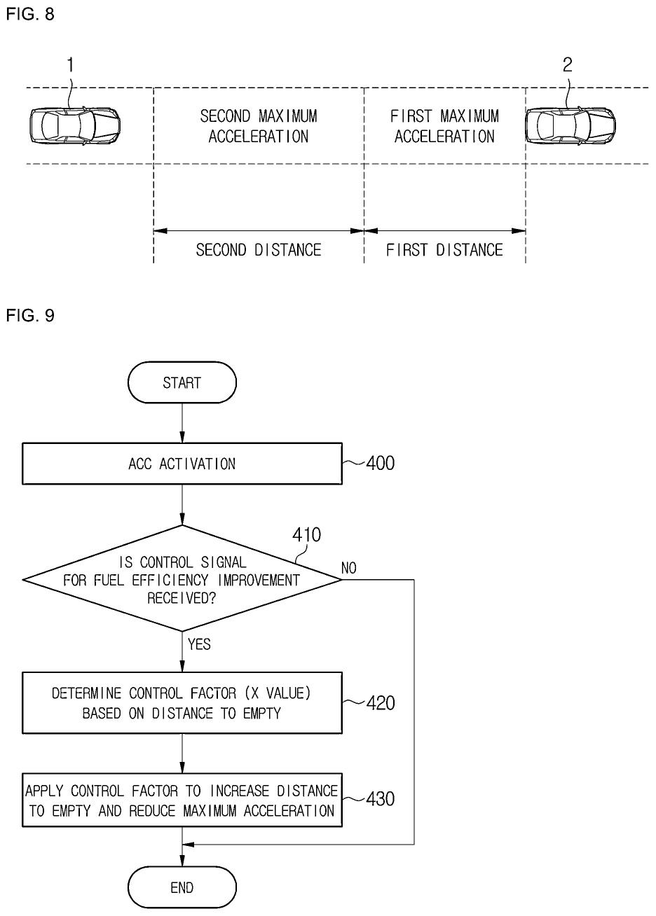

FIG. 3 shows a block diagram of functional modules of a controller included in a driving assistance apparatus according to an embodiment of the present disclosure. FIG. 4 schematically shows functions of a control factor determining module shown in FIG. 3. FIG. 5 schematically shows functions of a control module shown in FIG. 3. FIGS. 6 and 7 are graphs showing a relationship between a distance to empty and a control factor according to an embodiment of the present disclosure. FIG. 8 shows a driving control of the ACC according to turning-on of the fuel warning light, according to an embodiment of the present disclosure.

The driving assistance apparatus 100 may provide the ACC function as described above. While a driver drives the vehicle 1 in a city by using the ACC, the vehicle 1 may repeatedly accelerate and decelerate at a low speed due to traffic congestion, a speed limit, a driving environment or the like. At this time, the controller 140 may calculate a required acceleration or deceleration for controlling a distance to a front vehicle 2 by processing data obtained by one or more above-described front sensors, and transmit the required acceleration or deceleration to one or more devices of the vehicle 1 that perform functions related to the ACC. A positive value of the required acceleration may correspond to a situation in which acceleration of the vehicle 1 is required. In this case, the driving assistance apparatus 100 may perform a control for increasing a speed. A negative value of the required acceleration may correspond to a situation in which deceleration of the vehicle 1 is required. In this case, the driving assistance apparatus 100 may calculate a braking torque for reducing a speed of the vehicle 1 and reduce the speed of the vehicle 1 according to the calculated braking torque.

Meanwhile, when the fuel (or charging) warning light is turned on because the fuel level or the charged power level is below a predetermined threshold level while the vehicle 1 travels, the vehicle 1 may need to move to a gas or charging station located within a distance to empty to fill fuel or charge a battery. The distance to empty is an approximate distance the vehicle 1 is capable of driving with the amount of fuel remaining in a fuel tank. In the present disclosure, although fueling is described as an example, it should be understood that charging corresponds to a concept of fueling in a case of an electric vehicle that travels with energy stored in a battery. Therefore, for convenience of description, the term of fueling is used in the present disclosure, but the term of fueling should be interpreted as a term including both supplying fuel and charging electric power in the present disclosure.

In a case in which a gas station is found at a location close to the vehicle 1 within the distance to empty, there may be no problem. However, in a case in which a gas station is located at a long distance, a driver may have feeling of anxiety. To relieve such anxiety, some embodiments of the present disclosure provide a method for efficiently consuming a remaining amount of fuel or using a minimum amount of fuel by changing or adjusting an ACC control method when the fuel warning light is turned on. Hereinafter, an embodiment of the method will be described in detail.

Referring to FIG. 3, the controller 140 may include a plurality of functional modules. Each module may be implemented as a hardware module (for example, Application-Specific Integrated Circuit (ASIC) or Field-Programmable Gate Array (FPGA)) included in the processor 141, and/or a software module (for example, an application program or data) stored in the memory 142.

As shown in FIG. 3, the controller 140 may include a control factor determining module 210 and a control module 250.

When the fuel warning light is turned on or a command for fuel efficiency improvement or fuel efficiency function is received from the driver during the activation of the ACC function, the control factor determining module 210 of the controller 140 may perform an operation 211 of checking a distance to empty of the vehicle 1 to determine a control factor (x value). The control factor may be a value for adjusting a main controlled target of the ACC, such as a distance to a front vehicle, a maximum allowable acceleration of a host vehicle, a maximum allowable speed of a host vehicle, etc., to enable the vehicle 1 to arrive at a destination such as a gas or charging station while minimizing or efficiently performing fuel consumption when the fuel warning light is turned on or the request for fuel efficiency improvement or performance of a fuel efficiency function is received from the driver during activation of the ACC.

The control factor may have a value that changes according to a distance to empty and the control factor may be inversely proportional to the distance to empty, as shown in FIG. 6. That is, as the distance to empty is longer, the control factor may have a smaller value, and as the distance to empty is shorter, the control factor may have a greater value. As such, the control factor may be a value changing according to a change of a distance to empty, and a table in which control factors are mapped to distances to empty may have been preset and stored in advance in the memory 142.

The control factor may be a value for adjusting a main controlled target of the ACC, such as a distance to a front vehicle, a maximum allowable acceleration of a host vehicle, a maximum allowable speed of the host vehicle, etc., as described above, and more specifically, the control factor may function to increase a distance to a front vehicle, reduce a maximum allowable acceleration of a host vehicle, and reduce a maximum allowable speed of the host vehicle.

The x value as the control factor may be multiplied by an existing distance (e.g. a current set distance) to a front vehicle 2 set in the ACC (hereinafter a “first distance”) (e.g. first distance*x), to increase the existing distance to the front vehicle 2. That is, a distance (e.g. first distance+second distance) increased by adding the first distance to a second distance calculated by multiplying the first distance by the x value as the control factor may be set to a distance to a front vehicle 2.

Also, a reciprocal number of the x value as the control factor may be multiplied by an existing maximum allowable acceleration (e.g. a current set maximum allowable acceleration) set in the ACC (hereinafter, referred to as a first maximum acceleration) (first maximum acceleration*1/X) to determine a second maximum allowable acceleration that is smaller than the existing maximum allowable acceleration. The determined second maximum allowable acceleration may be set to a maximum allowable acceleration in a section corresponding to the second distance.

Also, a speed control factor (y value) may be added to a speed of the front vehicle 2, and the added result may be set to a maximum allowable speed of the ACC. Herein, the y value as the speed control factor may be a value that is inversely proportional to the x value as the control factor, and the y value may have been calculated in advance according to a change of the x value and then pre-stored in the memory 142. As alternative examples, the y value as the speed control factor may be selected by a driver, or the y value may have been pre-stored in advance as a constant value to be applied for calculation of a maximum allowable speed when the fuel warning light is turned on or the request for fuel efficiency improvement or performance of a fuel efficiency function is received from the driver during activation of the ACC.

The control factor determining module 210 of the controller 140 may perform an operation 212 of checking a distance from a current location to a destination in addition to the distance to empty. The above-described control factor may have a higher value as the distance to the destination is longer, under a condition of the same distance to empty. As shown in FIG. 7, as a value of subtracting a distance to a destination from a distance to empty is smaller, that is, as a distance to a destination is longer, a gradient value representing a degree of change of a control factor according to a change of a distance to empty may be greater (a line a at FIG. 7). Accordingly, under the condition of the same distance d to empty, the x value as the control factor may have a greater value x1 (>x2) as a distance to a destination is longer.

In contrast, under the condition of the same distance to empty, the above-described control factor may have a smaller value as a distance to a destination is shorter. As shown in FIG. 7, as a value of subtracting a distance to a destination from a distance to empty is greater, that is, as a distance to a destination is shorter, a gradient value representing a degree of change of a control factor according to a change of a distance to empty may be smaller (a line b at FIG. 7). Accordingly, under the condition of the same distance d to empty, the x value as the control factor may have a smaller value x2 (<x1) as a distance to a destination is shorter.

That is, as described above, the control factor may be a factor of which a value is determined according to a distance to empty and a distance to a destination, and the control factor may have been calculated in advance according to a value of subtracting a distance to a destination from a distance to empty and stored in the form of a table (e.g. a lookup table) in the memory 142.

The control factor determining module 210 may an operation 213 of determining a control factor based on the distance to empty and the distance to the destination, as described above.

After the control factor determining module 210 performs the operation 213 of determining the control factor for changing or adjusting a control of the ACC, the control module 250 may perform an operation 251 of increasing a distance to a front vehicle based on the determined control factor.

Referring to FIG. 8, the control module 250 may change a set distance to a front vehicle 2 to increase an existing distance to the front vehicle 2, set in the ACC, by multiplying the x value by the first distance as the existing distance to the front vehicle 2 (e.g. first distance*X). That is, the control module 250 may adjust a set distance to the front vehicle to increase the existing distance to the front vehicle 2 by adding the first distance to a second distance obtained by multiplying the x value as the control factor by the first distance (e.g. first distance+second distance).

Also, the control module 250 may perform an operation 252 of reducing a maximum allowable acceleration based on the determined control factor.

The control module 250 may determine a second maximum allowable acceleration which is lower than an existing maximum allowable acceleration set in the ACC by multiplying a reciprocal number of the x value as the control factor by a first maximum allowable acceleration as the existing maximum acceleration (e.g. first maximum allowable acceleration*1/X). Referring to FIG. 8, the control module 250 may set the determined second maximum allowable acceleration to a maximum allowable acceleration in a section corresponding to the second distance.

That is, as shown in FIG. 8, the control module 250 may control driving of the vehicle 1 with the first maximum limit for acceleration, which is a set existing maximum acceleration as a maximum limit for acceleration set in the ACC in the first distance corresponding to the existing distance to the front vehicle, and in a section corresponding to the second distance calculated after the fuel warning light is turned on or a control signal or command for controlling fuel efficiency (e.g. fuel efficiency improvement) is received from the driver, the control module 250 may control the driving of the vehicle 1 with the second maximum limit of the acceleration of the vehicle 1 reduced by applying the control factor to the maximum limit for acceleration set in the ACC.

In other words, after the fuel warning light is turned on or a control signal or command for controlling fuel efficiency (e.g. fuel efficiency improvement) is received from the driver, by increasing a distance to a front vehicle 2 and setting the maximum limit for acceleration to a second maximum limit for acceleration that is lower than the first maximum limit for acceleration, which is the set existing maximum acceleration, in a section corresponding to the increased distance as the second distance to control driving of the vehicle 1, fuel consumption may be reduced or minimized. The control module 250 may control the driving of the vehicle 1 by setting the second maximum limit for acceleration to a maximum limit for acceleration of the ACC in an entire section being a sum of the first distance and the second distance. Alternatively, the control module 250 may control the driving of the vehicle 1 by setting the second maximum limit for acceleration to a maximum limit for acceleration of the ACC in a section corresponding to the second distance, and when the vehicle 1 enters a section corresponding to the first distance, the control module 250 may control the driving of the vehicle 1 by setting the first maximum limit for acceleration to a maximum limit for acceleration of the ACC.

Also, the control module 250 may an operation 253 of reducing a maximum limit for a speed based on the determined control factor. The control module 250 may set a maximum limit for a speed of the ACC by adding a speed control factor (y value) to a speed of the front vehicle 2. Herein, the y value as the speed control factor may be a value that is inversely proportional to the x value as the control factor, and the y value may have been pre-calculated in advance according to a change of the x value and stored in the memory 142. As other examples, the y value as the speed control factor may be selected by the driver, or the y value may have been pre-stored in advance as a constant value to be applied for calculation of a maximum limit for a speed when the fuel warning light is turned on or a control signal or command for controlling fuel efficiency (e.g. fuel efficiency improvement) is received from the driver during the activation of the ACC. The control module 250 may control the driving of the vehicle 1 by setting a maximum limit for a speed calculated by adding the above-described speed control factor to a maximum limit for a speed of the ACC in the entire section being the sum of the first distance and the second distance. Alternatively, the control module 250 may control the driving of the vehicle 1 by setting a maximum limit for a speed calculated by adding the above-described speed control factor to a maximum limit for a speed of the ACC in the section corresponding to the second distance, and when the vehicle 1 enters the section corresponding to the first distance, the control module 250 may control the driving of the vehicle 1 by setting the existing maximum speed to a maximum limit for a speed of the ACC.

When there is no front vehicle 2 unlike the above-described examples, the control module 250 may set the above-described second maximum limit for an acceleration to an acceleration of the ACC, and control the driving of the vehicle 1 with a maximum limit for a speed according to the driver's setting speed.

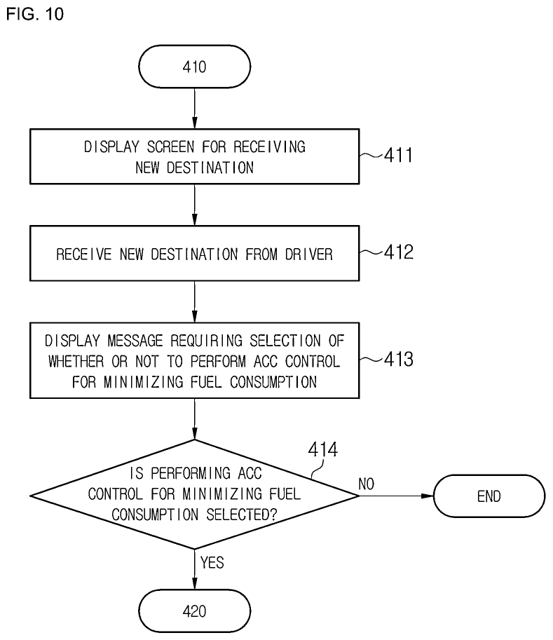

FIGS. 9 and 10 show flowcharts for illustrating a driving assistance apparatus according to an embodiment of the present disclosure.

Referring to FIG. 9, the ACC is activated at operation 400. While the ACC is being activated, the controller 140 may determine whether the fuel warning light is turned on or a control signal for controlling fuel efficiency (e.g. fuel efficiency improvement) is received (operation 410). When the controller 140 determines that the fuel warning light is turned on or the control signal for controlling the fuel efficiency (e.g., fuel efficiency improvement) is received, the controller 140 may determine a control factor (e.g., x value) based on a distance to empty (operation 420), increase a distance from a host vehicle to a front vehicle by applying the control factor, and reduce a maximum limit for an acceleration of the host vehicle, thereby performing the ACC control (operation 430).

When the fuel warning light is turned on or the control signal for controlling fuel efficiency (e.g. fuel efficiency improvement) is received from the driver during the activation of the ACC function, the controller 140 may check a distance to empty of the vehicle 1 to determine a control factor (x value). The control factor may be a value for adjusting a main controlled target of the ACC, such as a distance from a host vehicle 1 to a front vehicle 2, a maximum limit to an acceleration of the host vehicle 1, and a maximum limit to a speed of the host vehicle 1, etc., such that the host vehicle 1 can arrive at a destination with minimized fuel consumption, when the fuel warning light is turned on or a control signal for controlling fuel efficiency (e.g. fuel efficiency improvement) is received from the driver during the activation of the ACC.

The control factor may have a value that changes according to a distance to empty and is inversely proportional to the distance to empty, as shown in FIG. 6. For example, as the distance to empty is longer, the control factor may have a smaller value, and as the distance to empty is shorter, the control factor may have a greater value. As such, the control factor may be a value changing according to the change of the distance to empty, and a table (e.g. a lookup table) in which control factors are mapped to distances to empty may have been pre-stored in advance in the memory 142.

The control factor may be a value for adjusting a main controlled target of the ACC, such as a distance to a front vehicle, a maximum allowable acceleration of a host vehicle, a maximum allowable speed of a host vehicle, etc., as described above, and more specifically, the control factor may function to increase the distance from the host vehicle to the front vehicle, reduce a maximum limit for an acceleration of the host vehicle, and reduce a maximum limit for a speed of the host vehicle.

The controller 140 may increase an existing distance to a front vehicle 2, set in the ACC, by multiplying an x value as a control factor by a first distance being the existing distance to the front vehicle 2 (e.g., first distance*X). That is, the controller 140 may set a distance increased by adding the first distance to a second distance obtained by multiplying the x value as the control factor by the first distance, (e.g. first distance+second distance) to a distance to the front vehicle 2.

Also, the controller 140 may determine a second maximum limit for an acceleration that is smaller than an existing maximum limit for an acceleration set in the ACC by multiplying a reciprocal number of the x value as the control factor by a first maximum limit for an acceleration being the existing maximum limit for an acceleration (e.g. first maximum limit for acceleration*1/x). The controller 140 may set the determined second maximum limit for an acceleration to a maximum limit for an acceleration in a section corresponding to the second distance.

Also, the controller 140 may set a maximum limit for a speed of the ACC by adding a speed control factor (e.g., y value) to a speed of the front vehicle 2. Herein, the y value as the speed control factor may be a value that is inversely proportional to the x value as the control factor, and the y value may have been pre-calculated in advance according to a change of the x value and then pre-stored in the memory 142. As other examples, the y value as the speed control factor may be selected by the driver, or the y value may have been pre-stored in advance as a constant value to be applied for calculation of a maximum limit for a speed when the fuel warning light is turned on or a control signal for controlling fuel efficiency (e.g. fuel efficiency improvement) is received during the activation of the ACC.

The controller 140 may check a distance from a current location to a destination in addition to the distance to empty. The above-described control factor may have a greater value as the distance to the destination is longer, under a condition of the same distance to empty. As shown in FIG. 7, as a value of subtracting a distance to a destination from a distance to empty is smaller, that is, as a distance to a destination is longer, a gradient value representing a degree of change of a control factor according to a change of a distance to empty may be greater (e.g., a line a in FIG. 7). Accordingly, under the condition of the same distance d to empty, the x value as the control factor may have a greater value x1 (>x2) as a distance to a destination is longer.

In contrast, under the condition of the same distance to empty, the above-described control factor may have a smaller value as a distance to a destination is shorter. As shown in FIG. 7, as a value of subtracting a distance to a destination from a distance to empty is greater, that is, as a distance to a destination is shorter, a gradient value representing a degree of change of a control factor according to a change of a distance to empty may be smaller (e.g., a line b in FIG. 7). Accordingly, under the condition of the same distance d to empty, the x value as the control factor may have a smaller value x2 (<x1) as a distance to a destination is shorter.

That is, as described above, the control factor may be a factor of which a value is determined according to a distance to empty and a distance to a destination, and the control factor may have been pre-calculated in advance according to a value of subtracting a distance to a destination from a distance to empty and pre-stored in the form of a table (e.g. a lookup table) in the memory 142.

The controller 140 may determine a control factor based on a distance to empty and a distance to a destination, and increase a set distance to a front vehicle based on the determined control factor, as described above.

Referring to FIG. 8, the control module 250 may increase a set existing distance to the front vehicle 2, set in the ACC, by multiplying an x value as a control factor by a first distance as the set existing distance to the front vehicle 2 (e.g. first distance*x). That is, the controller 140 may set a distance increased by adding the first distance to a second distance obtained by multiplying an x value of a control factor by the first distance (e.g. first distance+second distance), to a distance to the front vehicle 2.

Also, the controller 140 may reduce a maximum limit for an acceleration of the host vehicle 1 based on the determined control factor.

The controller 140 may determine a second maximum limit for an acceleration which is smaller than a set existing maximum acceleration set in the ACC by multiplying a reciprocal number of the x value as the control factor by a first maximum limit for an acceleration being the existing maximum limit for an acceleration (first maximum acceleration*1/x). Referring to FIG. 8, the controller 140 may set the determined second maximum limit for an acceleration to a maximum limit for an acceleration in a section corresponding to the second distance.

That is, as shown in FIG. 8, the controller 140 may control the driving of the host vehicle 1 with a first maximum limit for an acceleration being an existing maximum limit for an acceleration as a maximum acceleration of the ACC in a first distance corresponding to an existing distance to a front vehicle, and in a section corresponding to a second distance calculated after the fuel warning light is turned on or a control signal for controlling fuel efficiency (e.g., fuel efficiency improvement) is received, the control module 250 may control the driving of the vehicle 1 with a second maximum limit for an acceleration reduced by applying a control factor to the maximum limit for an acceleration of the ACC.

In other words, after the fuel warning light is turned on or a control signal for controlling fuel efficiency (e.g., fuel efficiency improvement) is received, by increasing a distance to the front vehicle 2 and setting a second maximum limit for an acceleration that is smaller than a first maximum limit for an acceleration being an existing maximum acceleration to a maximum limit for an acceleration in a section corresponding to the increased distance as a second distance to control driving of the vehicle 1, fuel consumption may be minimized. The controller 140 may control the driving of the vehicle 1 by setting the second maximum limit for an acceleration to a maximum limit for an acceleration of the ACC in an entire section being a sum of the first distance and the second distance. Alternatively, the controller 140 may control the driving of the vehicle 1 by setting the second maximum limit for an acceleration to a maximum limit for an acceleration of the ACC in a section corresponding to the second distance, and when the vehicle 1 enters a section corresponding to the first distance, the controller 140 may control the driving of the vehicle 1 by setting the first maximum limit for an acceleration to a maximum limit for an acceleration of the ACC.

Also, the controller 140 may reduce a maximum limit for a speed of the host vehicle 1 based on the determined control factor. The controller 140 may set a maximum limit for a speed of the ACC by adding a speed control factor (y value) to a speed of the front vehicle 2. Herein, the y value as the speed control factor may be a value that is inversely proportional to the control factor x, and the y value may have been pre-calculated in advance according to a change of the x value and pre-stored in the memory 142. As other examples, the y value as the speed control factor may be selected by a driver, or the y value may have been pre-stored in advance as a constant value to be applied for calculation of a maximum limit for a speed when the fuel warning light is turned on or a control signal for controlling fuel efficiency (e.g. a fuel efficiency improvement) is received during the activation of the ACC. The controller 140 may control the driving of the vehicle 1 by setting a maximum limit for a speed calculated by adding the above-described speed control factor to a maximum limit for a speed of the ACC in the entire section being the sum of the first distance and the second distance. Alternatively, the controller 140 may control the driving of the vehicle 1 by setting a maximum limit for a speed calculated by adding the above-described speed control factor to a maximum limit for a speed of the ACC in the section corresponding to the second distance, and when the vehicle 1 enters the section corresponding to the first distance, the controller 140 may control the driving of the vehicle 1 by setting the existing maximum speed to a maximum speed of the ACC.

When there is no front vehicle 2 unlike the above-described examples, the controller 140 may set the above-described second maximum limit for an acceleration of the host vehicle 1 to an acceleration of the ACC, and control the driving of the host vehicle 1 with a maximum limit for a speed according to a speed set by the driver.

Referring to FIG. 10, when the fuel warning light is turned on or for a control command for controlling fuel efficiency (e.g. fuel efficiency improvement) is received, the controller 140 may display a screen for receiving a new destination on a display such as a navigation (operation 411), and when the driver inputs a new destination (operation 412), the controller 140 may display a message for requiring a selection of whether or not to perform an ACC control for reducing or minimizing fuel consumption to stably or securely arrive at the destination, through the display, etc. (operation 413). According to the driver's selection of performing the ACC control for reducing minimizing fuel consumption (operation 414), the controller 140 may perform operation 420 described above.

For example, when the fuel warning light is turned on, the controller 140 may display a list in which gas stations or charging stations located within a distance to empty are arranged in a close range order, on the display to provide the list for the driver. When the driver enters an input of selecting a gas station from the list, the selected gas station may be set to a destination. The controller 140 may display, on the display, a message for inquiring about whether or not to perform the ACC control for reducing or minimizing fuel consumption to securely or stably arrive at the set destination.

As another example, when the driver's input for controlling fuel efficiency (e.g. fuel efficiency improvement) is received, the controller 140 may display a screen for enabling the driver to input a destination on the display, or display a list in which destinations input in advance by the driver are arranged in a close range order on the display. When the driver inputs a destination, the selected destination may be set. The controller 140 may display, on the display, a message for inquiring about whether or not to perform the ACC control for reducing or minimizing fuel consumption to securely or stably arrive at the set destination.

When the driver inputs a selection of performing the ACC control for reducing or minimizing fuel consumption in the message displayed on the display, the controller 140 may determine a control factor, and apply the determined control factor to increase a distance from a host vehicle to a front vehicle and reduce a maximum limit for an acceleration of the host vehicle and a maximum limit for a speed for the host vehicle, as described above.

According to an aspect of the disclosure, by assisting the driving of the vehicle by reducing or minimizing fuel consumption when the fuel warning light is turned on or a command for controlling fuel efficiency (e.g. fuel efficiency improvement) is received from a driver during the activation of the ACC, it may be possible to stably or securely arrive at a target gas station.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A driving assistance apparatus comprising:
a front sensor included in a host vehicle and having a field of sensing in front of the host vehicle; and
a controller configured to perform Adaptive Cruise Control (ACC) based on a set distance from the host vehicle to a front vehicle and a set maximum limit for an acceleration of the host vehicle using the front sensor, and, in response to a control signal for controlling fuel efficiency while the ACC is being performed, increase the set distance from the host vehicle to the front vehicle and decrease the set maximum limit for the acceleration of the host vehicle.

2. The driving assistance apparatus of claim 1, wherein the controller is configured to determine a control factor for adjusting the set distance from the host vehicle to the front vehicle and the set maximum limit for the acceleration of the host vehicle based on a distance to empty in response to a control signal for turning on a fuel warning light or the control signal for controlling the fuel efficiency.

3. The driving assistance apparatus of claim 2, wherein the control factor is inversely proportional to the distance to empty.

4. The driving assistance apparatus of claim 2, wherein the controller is configured to determine the control factor to be a larger value as a distance from a current location of the host vehicle to a destination is longer.

5. The driving assistance apparatus of claim 2, wherein the controller is configured to determine the control factor to be a smaller value as a distance from a current location of the host vehicle to a destination is shorter.

6. The driving assistance apparatus of claim 2, wherein the controller is configured to determine a first set distance to the front vehicle, which is set before the control signal for controlling the fuel efficiency is received, and determine a second set distance based on the control factor for adjusting the set distance from the host vehicle to the front vehicle and the set maximum limit for the acceleration of the host vehicle.

7. The driving assistance apparatus of claim 6, wherein the controller is configured to increase the set distance from the host vehicle to the front vehicle by adding the second set distance, determined based on the control factor, to the first set distance, set before the control signal for controlling the fuel efficiency is received.

8. The driving assistance apparatus of claim 2, wherein the controller is configured to determine a second set maximum limit to an acceleration of the host vehicle, which is smaller than a first set maximum limit to the acceleration of the host vehicle set before the control signal for controlling the fuel efficiency is received, based on the control factor and the first maximum limit to the acceleration of the host vehicle.

9. The driving assistance apparatus of claim 8, wherein the controller is configured to determine the second maximum limit to the acceleration of the host vehicle as a maximum limit to the acceleration of the ACC in a section corresponding to the increased set distance to the front vehicle.

10. The driving assistance apparatus of claim 2, wherein the controller is configured to determine a maximum limit to a speed of the ACC based on a speed control factor, which is inversely proportional to the control factor for adjusting the set distance from the host vehicle to the front vehicle and the set maximum limit for the acceleration of the host vehicle, and a speed of the front vehicle.

11. A method for assisting driving, the method comprising:
processing data of a front sensor having a field of sensing a front direction of a host vehicle;
performing Adaptive Cruise Control (ACC) based on a set distance from the host vehicle to a front vehicle and a set maximum limit for an acceleration of the host vehicle using the processed data of the front sensor; and
in response to a control signal for controlling fuel efficiency while the ACC is being performed, increasing the set distance from the host vehicle to the front vehicle and decreasing the set maximum limit for the acceleration of the host vehicle.

12. The method of claim 11, wherein the increasing of the set distance from the host vehicle to the front vehicle and the decreasing of the set maximum limit for the acceleration of the host vehicle comprises determining a control factor for adjusting the set distance from the host vehicle to the front vehicle and the set maximum limit for the acceleration of the host vehicle based on a distance to empty, in response to a control signal for turning on a fuel warning light or the control signal for the fuel efficiency.

13. The method of claim 12, wherein the control factor is inversely proportional to the distance to empty.

14. The method of claim 12, wherein the control factor is determined to be a larger value as a distance from a current location of the host vehicle to a destination is longer.

15. The method of claim 12, wherein the control factor is determined to be a smaller value as a distance to a destination from a current location of the host vehicle is shorter.

16. The method of claim 12, further comprising determining a first set distance to the front vehicle, which is set before the control signal for controlling the fuel efficiency is received, and determining a second set distance based on the control factor for adjusting the set distance from the host vehicle to the front vehicle and the set maximum limit for the acceleration of the host vehicle.

17. The method of claim 16, further comprising increasing the set distance from the host vehicle to the front vehicle by adding the second distance, determined based on the control factor, to the first distance, set before the control signal for controlling the fuel efficiency is received.

18. The method of claim 12, further comprising determining a second set maximum limit to an acceleration of the host vehicle, which is smaller than a first set maximum limit to an acceleration of the host vehicle set before the control signal for controlling the fuel efficiency is received, based on the control factor and the first set maximum limit to the acceleration of the host vehicle.

19. The method of claim 18, further comprising determining the second set maximum limit to the acceleration of the host vehicle as a maximum limit to the acceleration of the ACC in a section corresponding to the increased set distance from the host vehicle to the front vehicle.

20. The method of claim 12, further comprising determining a maximum limit to a speed of the ACC based on a speed control factor, which is inversely proportional to the control factor for adjusting the set distance from the host vehicle to the front vehicle and the set maximum limit for the acceleration of the host vehicle, and a speed of the front vehicle.
